(19) United States
(12) Patent Application Publication
(10) Pub. No.: US 2024/0358570 A1
(43) Pub. Date: Oct. 31, 2024

(54) TRANSFER DEVICE

(71) Applicant: Ellevate LLC, Eagan, MN (US)

(72) Inventors: Lindsay Lankford, Eagan, MN (US); Ronald Frazzini, Eagan, MN (US); Alejandro Behling, Eagan, MN (US); Nicholas Hoffman, Eagan, MN (US); Emily Fraser, Eagan, MN (US); Noah Olson, Eagan, MN (US); Amy Larson, Eagan, MN (US); Isabella Kemling, Eagan, MN (US); Rebekah Gratz, Eagan, MN (US); Autumn Schuldt, Eagan, MN (US); Isidora Mack, Eagan, MN (US); Matthew Brown, Eagan, MN (US)

(21) Appl. No.: 18/646,404

(22) Filed: Apr. 25, 2024

Related U.S. Application Data
(60) Provisional application No. 63/461,661, filed on Apr. 25, 2023.

(51) Int. Cl. A61G 7/10

(52) U.S. Cl. CPC A61G 7/1017; A61G 7/1019; A61G 7/1046; A61G 7/1051

(57) ABSTRACT

A transfer device includes a mobile platform and a lifting assembly extending upwards from the mobile platform. A rotation mechanism forms a part of the mobile platform and is configured to rotate the mobile platform. A lift mechanism forms a part of the lifting assembly and is configured to lift and lower the lifting assembly.

### CROSS-REFERENCE TO RELATED APPLICATION(S)

This application claims priority to U.S. Provisional Application No. 63/461,661, filed on Apr. 25, 2023, and entitled “Transfer Device,” the disclosure of which is incorporated by reference in its entirety.

### BACKGROUND

The present disclosure relates to durable medical equipment, and in particular, to a transfer device.

People with limited mobility often require a transfer device to assist with standing and pivoting when transferring between two positions, i.e., from a wheelchair to a commode. Current transfer devices require a caregiver to assist in transferring the patient. Hiring a caregiver can be very expensive and caregivers may only be available during certain periods of the day. People with limited mobility could benefit from a transfer device that provides independence.

### SUMMARY

A transfer device includes a mobile platform and a lifting assembly extending upwards from the mobile platform. A rotation mechanism forms a part of the mobile platform and is configured to rotate the mobile platform. A lift mechanism forms a part of the lifting assembly and is configured to lift and lower the lifting assembly.

A method of using a transfer device to lift and rotate a user includes wrapping a belt around a waist of a user, and positioning feet of the user on a mobile platform of the transfer device. The user is lifted from a sitting position to a standing position by actuating a lift mechanism of the transfer device. The user is rotated by actuating a rotation mechanism of the transfer device.

### BRIEF DESCRIPTION OF THE DRAWINGS

FIG. 1 is a perspective view of a first embodiment of a transfer device.

FIG. 2 is a bottom view of the first embodiment of the transfer device.

FIG. 3 is a perspective view of the first embodiment of the transfer device including a transfer belt.

FIG. 4 is a perspective view of a second embodiment of a transfer device.

FIG. 5 is a bottom view of the second embodiment of the transfer device.

FIG. 6 is a side view of the second embodiment of the transfer device.

FIG. 7 is a perspective view of a third embodiment of a transfer device.

FIG. 8 is a side view of a mobile platform of the third embodiment of the transfer device.

FIG. 9 is a bottom view of the mobile platform of the third embodiment of the transfer device.

FIG. 10 is a perspective view of a frame of the third embodiment of the transfer device.

FIG. 11 is a perspective view of the third embodiment of the transfer device showing a user using the transfer device.

### DETAILED DESCRIPTION

People with limited mobility require assistance with transfers between two positions, i.e., from a wheelchair to a commode. The transfer device embodiments discussed herein allow a user to move between two positions without the assistance of a caregiver, increasing the user's independence and saving cost in having to hire a caregiver. When individuals are unable to transfer themselves of their own volition, they need a caregiver's assistance. Frequently individuals will not have a caregiver's assistance, as caregivers are expensive and there are a limited number of caregivers available to hire. Users could benefit from having a transfer device in their homes that allows them to be more independent.

The embodiments of transfer devices described herein can have a moderate base of support that is sized (for example, 36 inches (91.44 centimeters) or less in width in some instances, preferably 32 inches (81.28 centimeters) or less in width, and more preferably 30 inches (76.2 centimeters) or less in width) to allow it to fit through doors, allowing for multiple transfer locations throughout a user's home. The main areas that would need assistance with transfers would be between a wheelchair and a bed, between a wheelchair and a toilet/commode, and between a wheelchair and a recliner/chair.

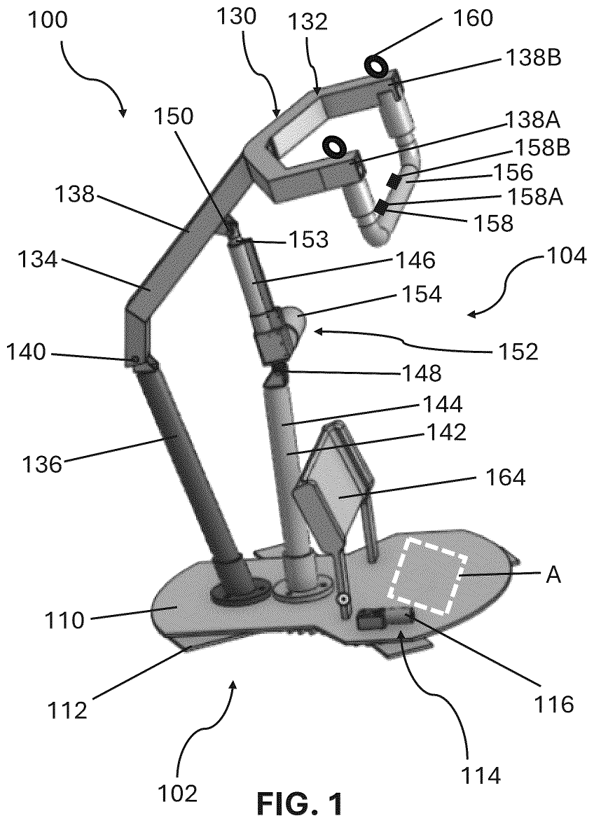

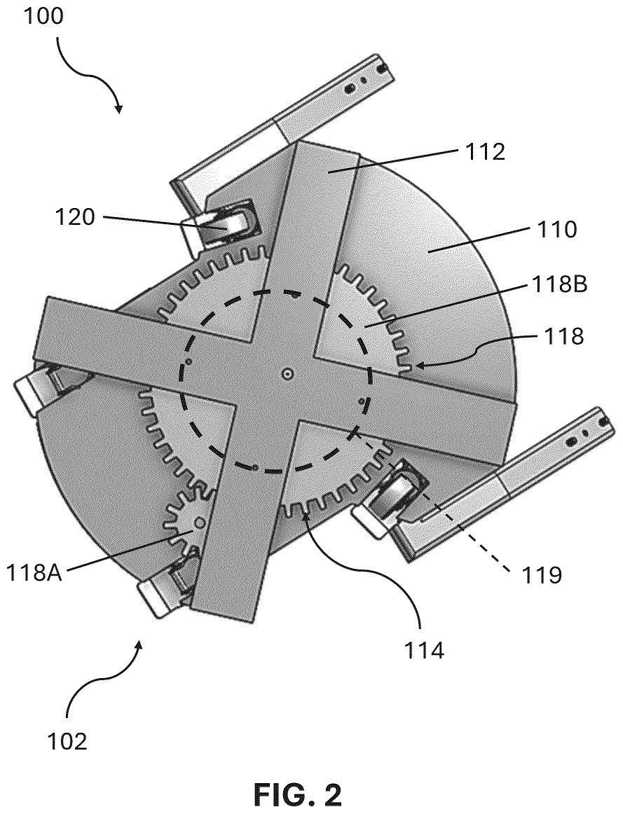

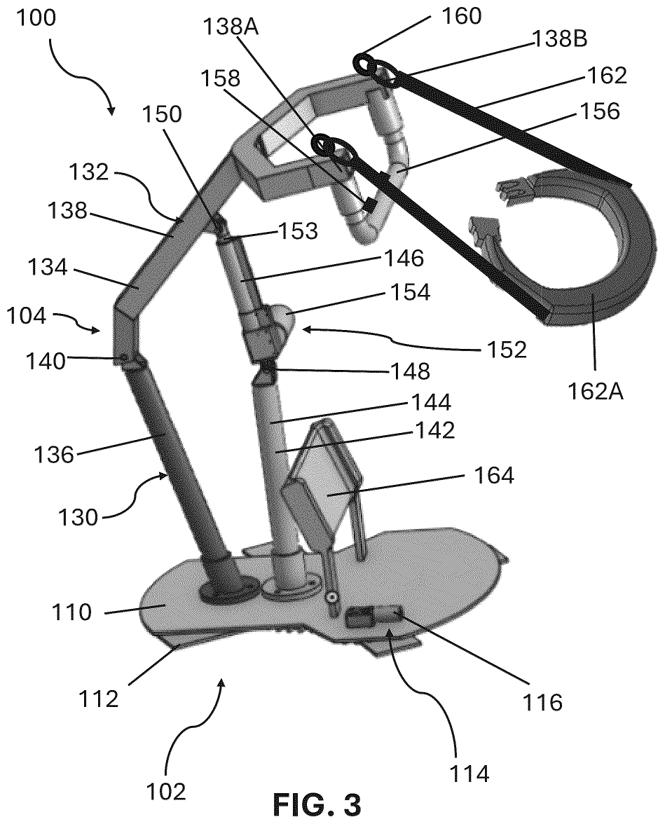

FIG. 1 is a perspective view of transfer device 100. FIG. 2 is a bottom view of transfer device 100. FIG. 3 is a perspective view of transfer device 100 including transfer belt 162. FIGS. 1-3 will be discussed together. Transfer device 100 includes mobile platform 102 and boom arm 104 (shown in FIGS. 1 and 3). Mobile platform 102 includes base 110, brace plate 112, rotation mechanism 114, rotation motor 116 (shown in FIGS. 1 and 3), rotation gears 118 (shown in FIG. 2) (including first gear 118A (shown in FIG. 2) and second gear 118B (shown in FIG. 2)), bearing 119 (shown in FIG. 2), and wheels 120 (shown in FIG. 2). FIGS. 1 and 3 shows boom arm 104, which includes arm frame 130, four-bar linkage 132, first arm 134, first bar 136, second bar 138 (including first prong 138A and second prong 138B), first arm pivot point 140, second arm 142, third bar 144, linear actuator 146, second arm pivot point 148, arm frame pivot point 150, lift mechanism 152, extendable portion 153, pivot motor 154, handle 156, controls 158 (including rotate control 158A (shown in FIG. 1) and lift control 158B (shown in FIG. 1)), and hooks 160. FIG. 3 further shows transfer belt 162 and padding 162A. FIGS. 1 and 3 further shows shin rest 164. FIG. 1 further shows box A.

Transfer device 100 can execute a sit-to-stand transfer, a pivot transfer, and a stand-to-sit transfer. Transfer device 100 can achieve a transfer that involves two components: the lift and lower function (sit-to-stand function and stand-to-sit function) and the rotation function (pivot function). During a sit-to-stand transfer, the user can use transfer device 100 to raise themselves from a seated position, for example in the wheelchair, to an upright, standing position; during a pivot transfer, the user can use transfer device 100 to rotate while in the upright, standing position, for example from in front of the wheelchair to in front of a commode; and during a stand-to-sit transfer, the user can use transfer device 100 to lower themselves from the upright, standing position to a seated position, for example onto the commode. These transfer types are most commonly used in the movement from a wheelchair to a commode/toilet, but transfer device 100 can be used for any transfer that would involve a lift and rotation, for example from a wheelchair to a bed, chair/recliner, or any other stationary surface.

As shown in FIG. 1, transfer device 100 includes mobile platform 102 and boom arm 104 extending upwards from and connected to mobile platform 102. Mobile platform 102 of transfer device 100 is designed to support the weight of a 300-pound person and prevent tipping of transfer device 100 during use. Mobile platform 102 includes base 110 that is a top plate of mobile platform 102. Base 110 has a partially rectangular and partially disc shape in the embodiment shown in FIGS. 1-3. In alternate embodiments, base 110 can have any suitable shape, including rectangular or square. Base 110 can be made from steel in a first embodiment. In alternate embodiments, base 110 can be made from any suitable material and can have any suitable thickness. Brace plate 112 is part of mobile platform 102 and forms a bottom stabilizing portion of mobile platform 102. Brace plate 112 is positioned below base 110 in mobile platform 102. Brace plate 112 is a crossbar in the shape of an X in the embodiment shown in FIGS. 1-3, but can have any suitable shape in alternate embodiments. For example, brace plate 112 can be rectangular or square in shape. Brace plate 112 is configured to rest on the floor to stabilize transfer device 100 when transfer device 100 is in use.

Mobile platform 102 also includes rotation mechanism 114, which includes rotation motor 116 and rotation gears 118. Rotation mechanism 114 forms a part of mobile platform 102 and is configured to rotate transfer device 100. Rotation motor 116 is positioned on a top of base 110 of mobile platform 102. As shown in FIG. 2, rotation gears 118 are positioned below base 112 and above brace plate 112. Rotation gears 118 include first gear 118A and first gear 118B. First gear 118A is connected to rotation motor 116 with a shaft that extends through base 112. In alternate embodiments, rotation motor 116 can be mounted on a bottom side of base 110 and connected to first gear 118A using any suitable mechanism. First gear 118A is a small planetary gear. Teeth of first gear 118A are engaged in teeth of second gear 118B. Second gear 118B is a large stationary gear. Bearing 119 is positioned between second gear 118B and base 102 in the embodiment shown in FIGS. 1-3. Base 102 is bolted to bearing 119, which in turn is mounted to second gear 118B. Bearing 119 is a rotatable bearing plate turntable in the embodiment shown in FIGS. 1-3. In alternate embodiments, bearing 119 can be any suitable bearing. Bearing 119 allows base 110 to rotate smoothly above second gear 118B and avoids friction.

In one embodiment, first gear 118A can have a diameter between 4 and 4.5 inches (10.16 and 11.43 centimeters) and include 12 teeth, and second gear 118B can have a diameter between 16 and 17 inches (40.64 and 43.18 centimeters) and include 48 teeth. First gear 118A and second gear 118B can be 0.5 inches (1.27 centimeters) thick and constructed from aluminum. An adapter connects a wider shaft of rotation motor 116 to a narrower shaft of first gear 118A. Rotation motor 116 has a maximum revolutions per minute (RPM) of 27 and a gear reduction ratio of 290:1. Rotation motor 116 is sized to withstand the acceleration torque of rotating a 300-pound user and to output a torque of 1.97 newton-meter (N-m) in the embodiment shown in FIGS. 1-3. In one embodiment, rotation motor 116 can have a maximum torque output of 10 newton-meter (N-m).

Rotation mechanism 114 is configured to rotate transfer device 100. Rotation mechanism 114 can rotate transfer device 100 clockwise or counterclockwise. A signal can be sent to rotation motor 116 to rotate rotation gears 118. Rotation motor 116 will rotate first gear 118A of rotation gears 118. In turn, first gear 118A will rotate second gear 118B due to the engagement of the teeth of first gear 118A and second gear 118B. The rotation function of transfer device 100 is achieved using a gear reduction to increase torque. Base 110 of transfer device 100 will rotate with second gear 118B. Brace plate 112 will not rotate with base 110, and as such provides stability to transfer device 100. Rotation mechanism 114, including rotation motor 116 and rotation gears 118, allows transfer device 100 to execute the pivot function of transfer device 100.

Wheels 120 are also included on mobile platform 102. Wheels 120 are kick-down wheels in the embodiment shown in FIGS. 1-3. Wheels 120 includes four wheels equally spaced around mobile platform 102 in the embodiment shown in FIGS. 1-3, but can include any number of wheels in any suitable arrangement in alternate embodiments. When wheels 120 are engaged, wheels 120 will extend below brace plate 112 and transfer device 100 can be moved from room to room. Transfer device 100 is moved when a user is not using transfer device 100. When kick down wheels 120 are disengaged, brace plate 112 will extend below wheels 120 to stabilize transfer device 100 on the floor and a user can use transfer device 100. To use transfer device 100, a user will place their feet on mobile platform 102. The placement for the user's feet is shown in FIG. 1 with dashed box labeled A. Mobile platform 102 is designed to have a low profile so that a top surface of base 110 is low to the ground. This allows a user to more easily step onto base 110 of mobile platform 102.

Transfer device 100 further includes boom arm 104 extending upwards from mobile platform 102. Boom arm 104, which could also be called a lifting assembly, is used to execute the sit-to-stand transfer and the stand-to-sit transfer. Boom arm 104 includes arm frame 130 extending upwards from mobile platform 102. Arm frame 130 includes four-bar linkage 132. The linkages that form four-bar linkage 132 are pivotable with respect to one another to lift and lower boom arm 104.

Arm frame 130 includes first arm 134 extending upwards from mobile platform 102. First arm 134 is positioned on base 110 opposite of box A where a user places their feet. First arm 134 includes first bar 136 and second bar 138 connected to first bar 136 at first arm pivot point 140. A first end of first bar 136 is connected to base 110, and a second end of first bar 136 is connected to a first end of second arm 138. First bar 136 is a straight bar. A first end of second bar 138 is connected to a second end of first bar 136, and a second end of second bar 138 has a Y-shape that splits into first prong 138A and second prong 138B. Second bar 138 also has a curve adjacent the first end of second bar 138.

Arm frame 130 includes second arm 142 extending upwards from mobile platform 102 that is spaced from first arm 130. Second arm 142 is positioned on base 110 between first arm 134 and box A where a user places their feet. Second arm 142 includes third bar 144 and linear actuator 146 connected to third bar 144 at second arm pivot point 148. A first end of third bar 144 is connected to base 110, and a second end of third bar 144 is connected to a first end of linear actuator 146. Third bar 144 is a straight bar. A first end of linear actuator 146 is connected to a second end of third bar 144, and a second end of linear actuator 146 is connected to second arm 142. Linear actuator 146 is extendable and retractable, i.e., capable of moving between a first position and a second position. Linear actuator 146 forms a fourth bar of second arm 142.

First arm 134 is connected to second arm 142 at arm frame pivot point 150. More specifically, the second end of linear actuator 146 of second arm 142 is connected to a middle portion of second bar 138 of first arm 134. Collectively, first bar 136, second bar 138, third bar 144, and linear actuator 146 form four-bar linkage 132 that make up arm frame 130. First bar 136, second bar 138, third bar 144, and linear actuator 146 are pivotable with respect to one another to lift and lower boom arm 104.

Linear actuator 146 also forms lift mechanism 152 of boom arm 104. Lift mechanism 152 forms a part of boom arm 104 and is configured to lift and lower boom arm 104. Linear actuator 146 includes extendable portion 153 and pivot motor 154. Extendable portion 153 is a telescope portion of linear actuator 146 in the embodiment shown in FIGS. 1-3. Pivot motor 154 is connected to extendable portion 153 adjacent a first end of extendable portion 153. Pivot motor 154 is configured to execute a lift and lower function for transfer device 100. A signal can be sent to pivot motor 154 to actuate lift mechanism 152. Pivot motor 154 actuates linear actuator 146 to move linear actuator 146 between a first position and a second position. In the first position, extendable portion 153 is fully retracted and a user using transfer device 100 will be in a seated position. FIGS. 1 and 3 show linear actuator 146 in the first, fully retracted position. In the second position, extendable portion 153 is extended and a user using transfer device 100 will be in a standing position. The second position can be a fully extended position of linear actuator 146 (and thus extendable portion 153) or it can be any other extended position between the retracted position and the fully extended position. Linear actuator 146 (and thus extendable portion 153) can be extended to different positions based on the height of the user using transfer device 100. Linear actuator 146 is sized to provide a maximum force of 1000 pounds, which allows a 300-pound user to be lifted with transfer device 100. Linear actuator 146 can have a stroke length of 6 inches (15.24 centimeters). In combination with the geometry of arm frame 130, this allows a user to be raised approximately 12 inches (30.48 centimeters) between a seated position and a standing position. In alternate embodiments, linear actuator 146 can have any suitable stroke length and the user can be raised any suitable distance, for example 16 inches (40.64 centimeters) or 22 inches (55.88 centimeters).

As linear actuator 146 is actuated, first arm 134 will pivot at first arm pivot point 140, second arm 142 will pivot at second arm pivot point 148, and first arm 134 and second arm 142 will pivot with respect to one another at arm frame pivot point 150. First arm pivot point 140, second arm pivot point 148, and arm frame pivot point 150 allow boom arm 104 to move between a first position and a second position to execute a lift and lower function.

Rotation motor 116 and linear actuator 146 can both include a 12 Volt DC power adapter. Transfer device 100 can include a power cord that is connectable to a wall plug to provide power to rotation motor 116 and linear actuator 146. Rotation motor 116 and linear actuator 146 can be electrically coupled to a power source in any suitable manner. Rotation motor 116 can include a motor speed controller to allow for appropriate acceleration of rotation motor 116. Linear actuator 146 can include a speed control to reduce the speed at which boom arm 104 moves vertically.

Handle 156 is connected to first prong 138A and second prong 138B of second bar 138 of first arm 134. Handle 156 is an extended U-shape in the embodiment shown in FIGS. 1-3. In alternate embodiments, handle 156 can be one or handles having any shape and connected to transfer device 100 in any suitable manner. Handle 156 can be articulated so it is adjustable to different heights to accommodate different heights of users. Handle 156 is configured to be grasped by the user when transfer device 100 is being used.

Controls 158 are positioned on handle 156. Controls 158 are positioned so that it is easy for a user to actuate controls 158 when they are grasping handle 156. In the embodiment shown in FIGS. 1-3, controls 158 are positioned on a back side of handle 156 to enable case of use. Controls 158 can be positioned in any easily accessible position in alternate embodiments. Controls 158 include rotate control 158A and lift control 158B, as shown in FIG. 1. Rotate control 158A is coupled to rotation motor 116 through a wired or wireless connection. When a user actuates rotate control 158A, a signal is sent, through the wired or wireless connection, from rotate control 158A to rotation motor 116 to actuate rotation motor 116 and rotate transfer device 100. Rotate control 158A can include two separate controls that allow a user to select right rotation or left rotation, or rotate control 158A can be a toggle switch that allows a user to move the switch right or left to rotate transfer device 100 right or left. Lift control 158B is coupled to pivot motor 154 through a wired or wireless connection. When a user actuates lift control 158B, a signal is sent, through the wired or wireless connection, from lift control 158B to pivot motor 154 to actuate pivot motor 154 and execute a lift and lower function of transfer device 100. Lift control 158B can include two separate controls that allow a user to select a lift function or a lower function, or lift control 158B can be a toggle switch that allows a user to move the switch up or down (or alternatively left or right) to lift or lower transfer device 100. In the embodiment shown in FIGS. 1-3, controls 158 are toggles. In alternate embodiments, controls 158 can be any mechanism that is easily accessible and operable by a single hand to facilitate use by users with limited mobility and fine motor skills. Controls 158 are designed so that the user does not have to remove their hands from handle 156 in order to operate controls 158 and move transfer device 100 through a sit-to-stand transfer, a pivot transfer, or a stand-to-sit transfer.

Hooks 160 are connected to ends of second bar 138 of first arm 134. Two hooks 160 are provided in the embodiment shown in FIGS. 1-3, with one hook 160 connected to first prong 138A of second bar 138 and one hook 160 connected to second prong 138B of second bar 138. Any number of hooks 160 can be provided in alternate embodiments. Transfer belt 162 can be connected to hooks 160 and wrapped around a user to assist in lifting the user. Hooks 160 are eye hooks in the embodiment shown in FIGS. 1-3, but can be any suitable hooks in alternate embodiments. Further, any suitable connection mechanism capable of connecting to transfer belt 162 can used in alternate embodiments. Transfer belt 162 is configured to support the user during a lift and lower function and during a rotation function. Transfer belt 162 is wrapped around a user's waist and trunk region. Transfer belt 162 includes padding 162A that is positioned around the user's waist and trunk region. Padding 162A can be buckled around the user to secure transfer belt 162 to the user. Transfer belt 162 can have any suitable design in alternate embodiments. Arm frame 130 is designed so that transfer belt 162 pulls and lifts the user along a trajectory that resembles a human standing on their own. Transfer device 100 will pull a user both upwards and forwards at the same time to mimic the trajectory of a human standing on their own.

Shin rest 164 is connected to and extends upwards from mobile platform 102 in the embodiment shown in FIGS. 1-3. In alternate embodiments, shin rest 164 can be connected to transfer device 100 in any suitable manner, for example shin rest 164 can be attached to second arm 142. Shin rest 164 is positioned to so that a user of transfer device 100 can rest their shins on shin rest 164. Shin rest 164 provides a stable surface to support the user during the lift function of transfer device 100. Shin rest 164 also allows a user to properly locate their feet and legs on transfer device 100, as shin rest 164 can guide the user's feet placement forward and backwards. Shin rest 164 can also help to prevent a user from tipping forward and to either side. Shin rest 164 can have any suitable shape and design to comfortably accommodate the shins of a user. In the embodiment shown in FIGS. 1-3, shin rest 164 has raised edges to prevent a user's shins from sliding off of either side of shin rest 164. Shin rest 164 can also be padded in some embodiments to provide increased comfort to the user.

In combination, transfer belt 162 placed around a user's trunk and shin rest 164 supporting a user's shins prevent a user of transfer device 100 from falling forwards or tipping backwards or sideways. The sensation of being supported on both sides of the body is essential to allowing individuals with limited mobility independence and comfort in using transfer device 100.

To use transfer device 100, the user can place their feet onto mobile platform 102 and wrap transfer belt 162 around their waist and connect transfer belt 162 to hooks 160. Once the user has connected transfer belt 162 to transfer device 100, the user can grasp handle 156 and actuate linear actuator 146, and more specifically lift motor 154, by depressing one of controls 158 on handle 156. Linear actuator 146 can execute a lift function to move transfer device 100 between a sitting position and a standing position. The user will connect transfer belt 162 to transfer device 100 when transfer device 100 is in the sitting position. When linear actuator 146 is actuated, transfer device 100 will lift from the sitting position to the standing position (the lifting function). Once transfer device 100 is in the standing position, the user can actuate rotation motor 116 by depressing one of controls 158 on handle 156. Rotation motor 116 will then rotate rotation gears 118 to rotate transfer device 100 (the pivot function). Once transfer device 100 has been pivoted to the correct location, the user can actuate linear actuator 146, and more specifically lift motor 154, by actuating one of controls 158 on handle 156 to move transfer device 100 from the standing position to the sitting position (the lowering function). Transfer device 100 can be powered via a standard outlet.

Transfer device 100 can be 36 inches (91.44 centimeters) or less in width in some instances, preferably 32 inches (81.28 centimeters) or less in width, and more preferably 30 inches (76.20 centimeters) or less in width. This sizing allows transfer device 100 to easily fit through a standard size door. Transfer device 100 can be used in an individual's home, for example, in a bedroom or bathroom. The size of transfer device 100 has been selected to prevent interference with day-to-day tasks occurring within the home. Many families have cramped bathrooms or living spaces, thus transfer device 100 is sized so it can easily be transported from room to room. Wheels 120 allow a caregiver or a family member to easily roll transfer device 100 from one room to another, without requiring disassembly, heavy lifting, or other types of undue burden.

For physically weakened people, transfer device 100 is used to help them execute a sit-to-stand transfer, a pivot transfer, and a stand-to-sit transfer. In this process, the user is placed in front of transfer device 100 (either from a static seat or a wheelchair) with handle 156 and hooks 160 closest to the user. The user is as close to the center of mobile platform 102 as possible and leaning forward. The user attaches transfer belt 162 in the standard orientation for transfer belt 162: tightly secured (to avoid slippage) around their trunk and just below their ribcage or slightly lower if possible. The user then attaches transfer belt 162 to hooks 160 on first prong 138A and second prong 138B of second bar 138 of arm frame 130 with a latch mechanism or any other suitable attachment mechanism. The user's feet are firmly planted near the center of mobile platform 102 such that the entirety of their feet are on mobile platform 102 (no heel overhang) and are roughly shoulder-width apart. The sit-to-stand transfer is then initiated, which may involve several steps happening near-simultaneously. As they are able, the user will place both hands on handle 156, with one near controls 158. The user will also place their knees in front of shin rest 164 so that when the standing motion begins, shin rest 164 can provide additional support to the user. The user presses lift control 158B (which can include one button to lift transfer device 100 and one button to lower transfer device 100, or a toggle switch that can be moved between a lift position and a lower position), which actuates pivot motor 154 and causes linear actuator 146 to elongate. This raises boom arm 104 of transfer device 100, thus raising the user. It is likely at this time that the user may lean back into the support of transfer belt 162 and let transfer device 100 perform a majority of the lift. Transfer device 100 continues the lift until the user lets go of lift control 158B when they are fully supported in a standing position or the upper safety limit of pivot motor 154 is met.

At this point, the user presses rotate control 158A (which can include one button for right rotation and one button for left rotation or a toggle switch that can be moved right or left for right rotation or left rotation) to rotate mobile platform 102. This will actuate rotation mechanism 114, and more specifically rotation motor 116 and gears 118. Like with the lift function, the user continues to hold rotate control 158A until they have completed the necessary rotation that positions them in front of their desired “drop-off” location. If necessary, the user may take a hand off handle 156 to doff clothing from the lower half of their body before initiating the stand-to-sit transfer. Making sure to pay attention to where they are coming down, the user then presses lift control 158B (which can include one button to lift transfer device 100 and one button to lower transfer device 100, or a toggle switch that can be moved between a lift position and a lower position) until they are in the seated position or the lower limit of pivot motor 154 is reached. Once a user is in a seated position, they can detach transfer belt 162 if they desire. This completes one full round of use of transfer device 100.

Transfer device 100 allows a user to independently execute a sit-to-stand transfer, a pivot transfer, and a stand-to-sit transfer without the assistance of a caregiver. Transfer device 100 is designed to allow a user to don or doff clothing as necessary. This allows a user to transfer from a wheelchair to a commode/toilet. This is especially important in cases where a full time caregiver is not available, as it allows users to transfer between a wheelchair and a commode/toilet independently when a caregiver is not present to assist.

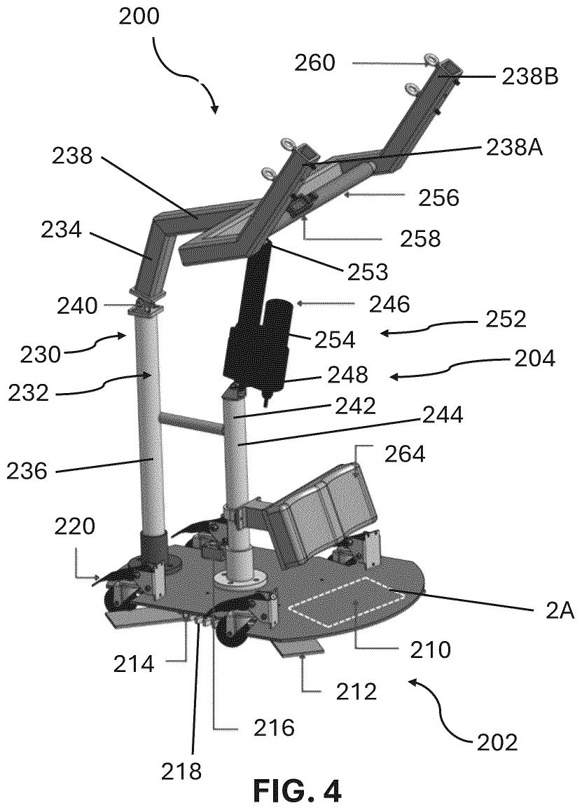

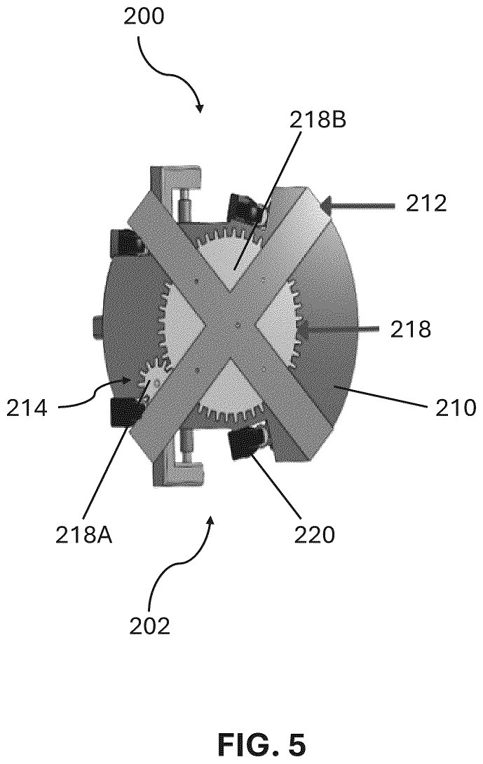

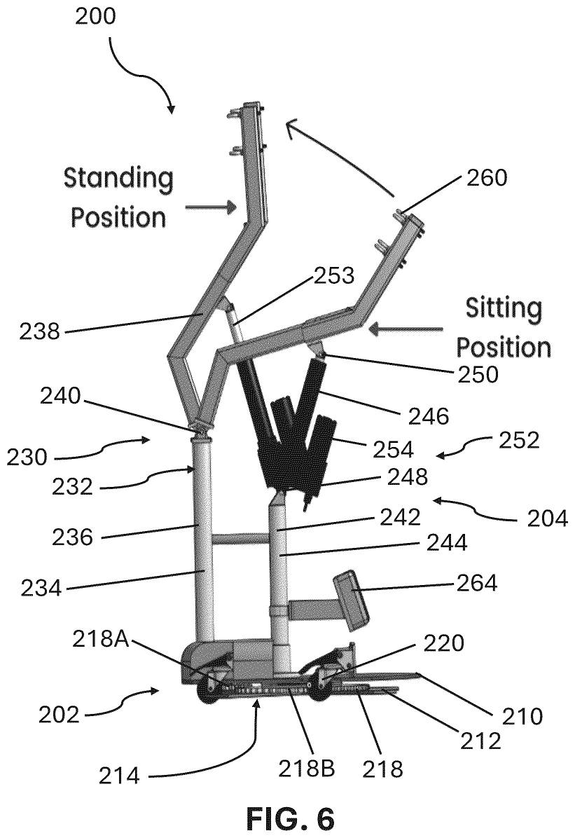

FIG. 4 is a perspective view of transfer device 200. FIG. 5 is a bottom view of transfer device 200. FIG. 6 is a side view of transfer device 200. FIGS. 4-6 will be discussed together. Transfer device 200 includes mobile platform 202 and boom arm 204 (shown in FIGS. 4 and 6). Mobile platform 202 includes base 210, brace plate 212, rotation mechanism 214, rotation motor 216 (shown in FIG. 4), rotation gears 218 (including first gear 218A (shown in FIGS. 5-6) and second gear 218B (shown in FIGS. 5-6)), and wheels 220. FIGS. 4 and 6 shows boom arm 204, which includes arm frame 230, four-bar linkage 232, first arm 234, first bar 236, second bar 238 (including first prong 238A (shown in FIG. 4) and second prong 238B (shown in FIG. 4)), first arm pivot point 240, second arm 242, third bar 244, linear actuator 246, second arm pivot point 248, arm frame pivot point 250 (shown in FIG. 6), lift mechanism 252, extendable portion 253, pivot motor 254, handle 256 (shown in FIG. 4), controls 258 (shown in FIG. 4), and hooks 260. FIGS. 4 and 6 further show shin rest 264. FIG. 4 also shows box 2A.

Transfer device 200 has the same general structure and design as transfer device 100 shown in FIGS. 1-3. The reference numerals that refer to the parts of transfer device 200 are incremented by one-hundred compared to the reference numerals that refer to the parts of transfer device 100 shown in FIGS. 1-3. While FIGS. 4-6 show slight variations in the design of transfer device 200 compared to transfer device 100 shown in FIGS. 1-3, transfer device 200 will function in the same general manner as transfer device 100 shown in FIGS. 1-3.

Transfer device 200 includes wheels 220 that are kickdown wheels that function as wheels 120 described above with respect to transfer device 100 shown in FIGS. 1-3. However, wheels 220 extend above a top end of base 210 so that they are accessible from a top side of mobile platform 220. This allows a user easy access to wheels 220 to move them between an engaged and disengaged position.

Transfer device 200 also includes handle 256 that extends between first prong 238A and second prong 238B of second bar 238. Handle 256 is a straight bar that is attached a middle position of first prong 238A and second prong 238B. Controls 258 are positioned on a front side of handle 256 so that they can be accessed by a user who is grasping handle 256.

Transfer device 200 also includes shin rest 264 that is attached to third bar 244 of second arm 242. Shin rest 264 is attached to third bar 244 using a clamp mechanism that allows shin rest 264 to be positioned at any point along third bar 244. This allows shin rest 264 to be positioned at variable heights to accommodate varying heights of users of transfer device 200. Shin rest 264 also has a curved shape on a front side of shin rest 264 to provide grooves upon which a user's shins are positioned. The grooves help to maintain the position on a user's shins in shin rest 264 and prevent a user's shins from sliding off of a side of shin rest 264.

As shown in FIG. 6, transfer device 200 is configured to be moved between a sitting position (labeled with a first arrow in FIG. 6) and a standing position (labeled with a second arrow in FIG. 6). In the sitting position, linear actuator 246 is in a retracted position and second bar 238 of first arm 232 is in a lowered, seated position. In the standing position, linear actuator 246 is extended and second bar 238 of first arm 232 is in a raised, standing position. In the standing position, extendable portion 253 of linear actuator 246 is extended, as shown in FIG. 6. FIG. 6 shows boom arm 204 in both the sitting position and the standing position. Boom arm 204 moved between the sitting position and the standing position to lift and lower the user using transfer device 200.

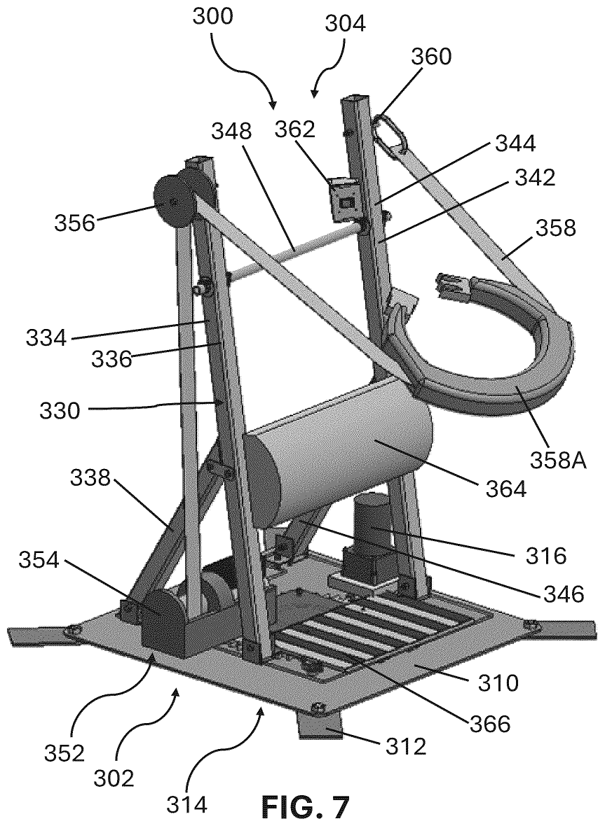

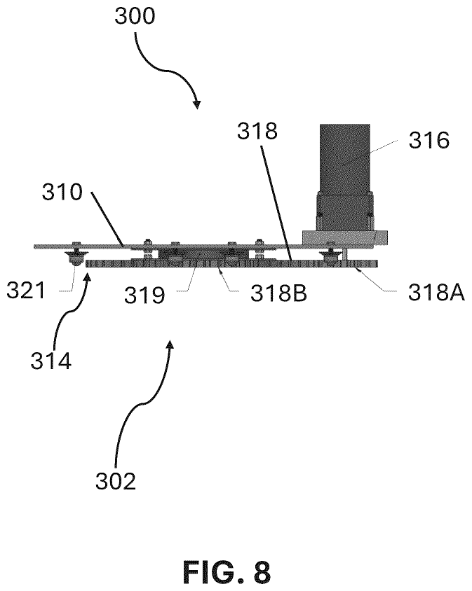

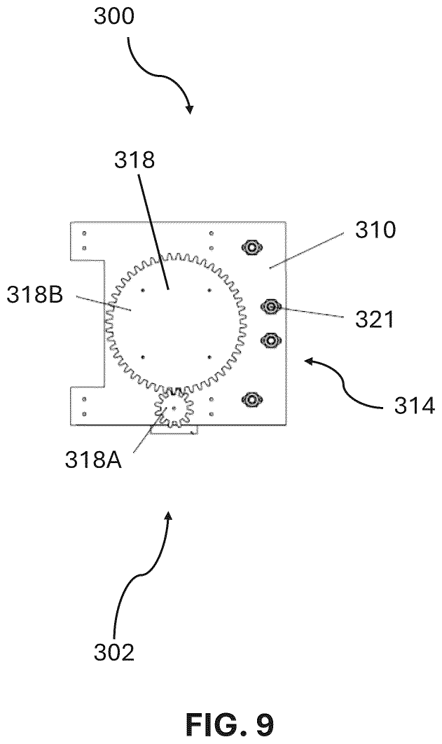

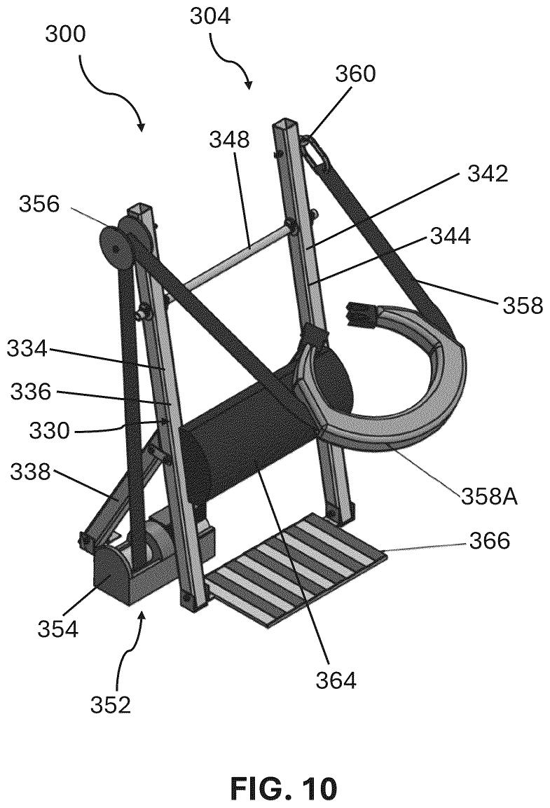

FIG. 7 is a perspective view of transfer device 300. FIG. 8 is a side view of mobile platform 302 of transfer device 300. FIG. 9 is a bottom view of mobile platform 302 of transfer device 300. FIG. 10 is a perspective view of lifting assembly 304 of transfer device 300. FIGS. 7-10 will be discussed together. Transfer device 300 includes mobile platform 302 (shown in FIGS. 7-9) and lifting assembly 304 (shown in FIGS. 7 and 10). Mobile platform 302 includes base 310 (shown in FIGS. 7-9), brace plate 312 (shown in FIG. 7), rotation mechanism 314 (shown in FIGS. 7-9), rotation motor 316 (shown in FIGS. 7-8), rotation gears 318 (shown in FIGS. 8-9) (including first gear 318A (shown in FIGS. 8-9) and second gear 318B (shown in FIGS. 8-9)), bearing 319 (shown in FIG. 8), and ball transfers 321 (shown in FIGS. 8-9). FIGS. 7 and 10 shows lifting assembly 304, which includes frame 330, first arm 334, first bar 336, second bar 338, second arm 342, third bar 344, fourth bar 346 (shown in FIG. 7), handle 348, lift mechanism 352, electric winch 354, pulley 356, belt 358 (including padding 358A), hook 360, and controls 362 (shown in FIG. 7). FIGS. 7 and 10 further show shin rest 364 and foot plate 366.

Mobile platform 302 of transfer device 300 has the same general structure and design as mobile platform 102 of transfer device 100 shown in FIGS. 1-3. The reference numerals that refer to the parts of mobile platform 302 of transfer device 300 are incremented by two-hundred compared to the reference numerals that refer to the parts of mobile platform 102 of transfer device 100 shown in FIGS. 1-3, including mobile platform 302, base 310, brace plate 312, rotation mechanism 314, rotation motor 316, and rotation gears 318 (including first gear 318A and second gear 318B). While FIGS. 7-10 show slight variations in the design of mobile platform 302 of transfer device 300 compared to mobile platform 102 of transfer device 100 shown in FIGS. 1-3, mobile platform 302 of transfer device 300 will function in the same general manner as mobile platform 102 of transfer device 100 shown in FIGS. 1-3.

Base 310 of mobile platform 302 of transfer device 300 is square shaped in the embodiment shown in FIGS. 7-10. Base 310 can be sized to be approximately 32 inches by 32 inches (81.28 centimeters by 81.28 centimeters). The corners of base 310 can be rounded to eliminate any sharp edges that a user could bump their foot against. Further, brace plate 312 can include legs that are extended to extend the size of mobile platform 302. The legs of brace plate 312 can be extendable using any suitable mechanism. Extending the legs of brace plate 312 allows the size of mobile platform 302 to be increased to provide increased stability when transfer device 300 is in use, while also allowing for easy movement of transfer device 300 in constrained places (i.e., a user's home) when the legs of brace plate 312 are not extended. Further, the legs of brace plate 312 can be attached to mobile platform 302 in any orientation, further allowing transfer device 300 to fit into constrained places or around fixtures, furniture, or other devices (i.e., a user's wheelchair).

FIG. 8 shows bearing 319 positioned between base 310 and second gear 318B. When rotation mechanism 314 is actuated to rotate mobile platform 302 and transfer device 300, base 310 will rotate with second gear 318B along bearing 319. Bearing 319 allows everything below bearing 319 to remain stationary (including brace plate 312) while allowing everything above bearing 319 to rotate (including base 310). Transfer device 300 also includes ball transfers 321 to further support base 310 and mobile platform 302 during the rotation function. The embodiment of transfer device 300 shown in FIGS. 7-10 includes four ball transfers 321. Transfer device 300 can include any suitable number of ball transfers 321 in alternate embodiments.

Transfer device 300 is not shown as having wheels in FIGS. 7-10, but transfer device 300 can have wheels similar to wheels 120 shown with respect to transfer device 100 shown in FIGS. 1-3. Transfer device 300 can have wheels to move transfer device 300 between rooms.

Transfer device 300 further includes lifting assembly 304 extending upwards from and connected to mobile platform 302. Lifting assembly 304 is used to execute the sit-to-stand transfer and the stand-to-sit transfer. Lifting assembly 304 includes frame 330. Frame 330 can be grasped by the user with their hands and offers support for the user during transfers. Frame 330 can be formed of aluminum square tubing in the embodiment shown in FIGS. 7-10, but can be formed of any suitable material in alternate embodiments.

Frame 330 includes first arm 334 extending upwards from mobile platform 302. First arm 334 is positioned on a first side of base 310. First arm 334 includes first bar 336 and second bar 338 connected to first bar 336. A first end of first bar 336 is connected to base 310, and a second end of first bar 336 extends at an angle upwards from the first end of first bar 336. First bar 336 is a straight bar. A first end of second bar 338 is connected to base 310, and a second end of second bar 338 is connected to a middle point of first bar 336. Second bar 338 is a straight bar and is used to support first bar 336.

Frame 330 includes second arm 342 extending upwards from mobile platform 302. Second arm 342 is positioned on a second side of base 310 opposite of first arm 334. Second arm 342 includes third bar 344 and fourth bar 346 connected to third bar 344. A first end of third bar 344 is connected to base 310, and a second end of third bar 344 extends at an angle upwards from the first end of third bar 344. Third bar 344 is a straight bar. A first end of fourth bar 346 is connected to base 310, and a second end of fourth bar 346 is connected to a middle point of third bar 344. Fourth bar 346 is a straight bar and is used to support third bar 344.

First bar 336 and third bar 344 extend at 10-degree angles with respect to a vertical axis in the embodiment shown in FIGS. 7-10. First bar 336 and third bar 344 are angled for comfort and to withstand the overall moment created by the user during the lift function and the lower function of transfer device 300.

Handle 348 is connected to and extends between first arm 334 and second arm 342. More specifically, handle 348 extends between first bar 336 of first arm 334 and third bar 344 of second arm 342. Handle 348 is a straight bar in the embodiment shown in FIGS. 7-10. In alternate embodiments, handle 348 can be one or more handles having any shape and connected to transfer device 300 in any suitable manner. Handle 348 is configured to be grasped by the user when transfer device 300 is being used. The height of handle 348 is configured to be reached by users who are seated and gives another anchor point for the user to ensure safe body positioning during the lift function and lower function.

Lifting assembly 304 also includes lift mechanism 352 that is configured to execute a lift function and a lower function of transfer device 300. Lift mechanism 352 includes electric winch 354, pulley 356, and belt 358. Electric winch 354 is positioned on base 310 of mobile platform 302. Pulley 356 is positioned on the second end of first bar 336 of first arm 334 of frame 330. Belt 358 extends from electric winch 354 and is wrapped around pulley 356. Hook 360 is positioned on the second end of third bar 344 of second arm 342 of transfer device 300. A first end of belt 358 is connected to electric winch 354, and a second end of belt 358 is releasably connected to hook 360. Belt 358 can be connected to hook 360 with a latch mechanism or any other suitable mechanism that allows belt 358 to be connected to and disconnected from hook 360.

A signal can be sent to electric winch 354 to actuate lift mechanism 352. Electric winch 354 is multidirectional and can wind belt 358 and unwind belt 358. In a first, unwound position, belt 358 can be wrapped around a seated user. In the embodiment shown in FIGS. 7-10, belt 358 includes padding 358A through which belt 358 extends. Padding 358A can be wrapped and secured around a user's waist to provide stability and comfort to the user during use of transfer device 300. Padding 358A can slide along belt 358 as belt 358 is wound and unwound with electric winch 354. During the lifting function, padding 358A is secured on the user's waist, and the user is raised evenly on both sides as belt 358 slides through padding 358A during winding and unwinding. When electric winch 354 is actuated, belt 358 will be wound into electric winch 354 to reach a second, wound position. In the second, wound position, belt 358 can be wound into electric winch 354 any amount that allows a user to move from a seated position to a standing position. As belt 358 is wound into electric winch 354 it will be guided with pulley 356. Belt 358 can also be unwound from electric winch 354 as a user moves from a standing position to a seated position.

Pulley 356 and hook 360 are aligned with one another to ensure that belt 358 maintains a secure position around the user. Pulley 356 and hook 360 are also positioned at a height that is configured to align with a user's hips when they are standing on transfer device 300. Once standing, padding 358A and belt 358 also act as an anchor with two points on each side of the waist to ensure that the user does not fall back or side to side during rotation of transfer device 300.

Controls 362 are positioned on third bar 344 of second arm 342 adjacent handle 348 in the embodiment shown in FIGS. 7-10. Controls 362 are positioned so that it is easy for a user to actuate controls 362 when they are grasping handle 348. Controls 362 can be positioned in any easily accessible location in alternate embodiments. Controls 362 include a rotate control and a lift control. The rotate control is coupled to rotation motor 316 through a wired or wireless connection. When a user actuates the rotate control, a signal is sent from the rotate control to rotation motor 316 to actuate rotation motor 316 and rotate transfer device 300. The rotate control can include two separate controls that allow a user to select right rotation or left rotation, or the rotate control can be a toggle switch that allows a user to move the switch right or left to rotate transfer device 300 right or left. The lift control is coupled to electric winch 354 through a wired or wireless connection. When a user actuates the lift control, a signal is sent from the lift control to electric winch 354 to actuate electric winch 354 and execute a lift and lower function of transfer device 300. The lift control can include two separate controls that allow a user to select a lift function or a lower function, or the lift control can be a toggle switch that allows a user to move the switch right or left to lift or lower transfer device 300. Controls 362 are designed so that the user does not have to remove their hands from handle 348 in order to operate controls 362 and move transfer device 300 through a sit-to-stand transfer, a pivot transfer, or a stand-to-sit transfer.

Shin rest 364 is connected to and extends between first arm 334 and second arm 342 in the embodiment shown in FIGS. 7-10. In alternate embodiments, shin rest 364 can be connected to transfer device 300 in any suitable manner. Shin rest 364 is positioned to so that a user of transfer device 300 can rest their shins on shin rest 364. Shin rest 364 provides a stable surface to support the user during the lift function of transfer device 300. Shin rest 364 also allows a user to properly locate their feet and legs on transfer device 300, as shin rest 364 can guide the user's feet placement forward and backwards. Shin rest 364 can also help to prevent a user from tipping forward and to either side. Shin rest 364 can have any suitable shape and design to comfortably accommodate the shins of a user. In the embodiment shown in FIGS. 7-10, shin rest 364 is padded and will cup the user's knees and shins to prevent the knees from buckling to the left or right during the lifting function.

In combination, belt 358 placed around a user's trunk and shin rest 364 supporting a user's shin prevent a user of transfer device 300 from falling forwards or tipping backwards. The sensation of being supported on both sides of the body is essential to allowing individuals with limited mobility independence and comfort in using transfer device 300. Transfer device 300 can also optionally include foot plate 366, which provides a clear indication of where a user should place their feet during use of transfer device 300.

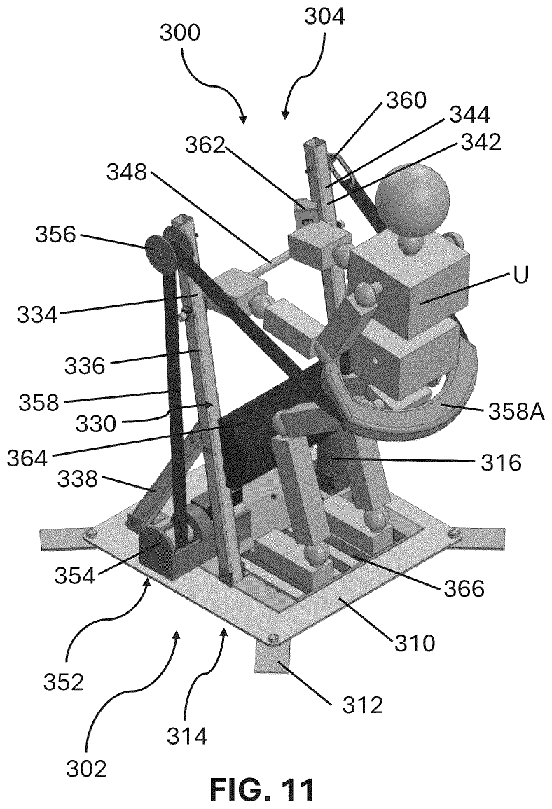

FIG. 11 is a perspective view of transfer device 300 showing a user using transfer device 300. Transfer device 300 includes mobile platform 302 and lifting assembly 304. Mobile platform 302 includes base 310, brace plate 312, rotation mechanism 314, rotation motor 316, rotation gears 318 (not shown in FIG. 11), bearing 319 (not shown in FIG. 11), and ball transfers 321 (not shown in FIG. 11). Lifting assembly 304 includes frame 330, first arm 334, first bar 336, second bar 338, second arm 342, third bar 344, fourth bar 346 (not shown in FIG. 11), handle 348, lift mechanism 352, electric winch 354, pulley 356, belt 358 (including padding 358A), hook 360, and controls 362. FIG. 11 further shows shin rest 364, foot plate 366, and user U.

The structure and design of transfer device 300 is described above with reference to FIGS. 7-10.

Prior to using transfer device 300, it can be moved to the exact location that it will be when used. Transfer device 300 should be set up so that the initial position of transfer device 300 is facing a wheelchair, bed, chair, or any other fixture a user can sit on. Transfer device 300 is also positioned so that upon executing the rotation function, a user can be lowered onto another fixture, for example a commode, a toilet, a wheelchair, a chair, etc. Once transfer device 300 is positioned in the correct location, brace plate 312 is engaged with the floor to stabilize transfer device 300. If brace plate 312 includes extendable legs, they can be extended to provide further stability for transfer device 300. The extension and positioning of brace plate 312 can vary depending on the room size, fixtures in the room, and the extent of rotation that is desired.

To user transfer device 300, a user can complete the following steps. The following steps are described with respect to transferring a user from a wheelchair to a toilet, but any transfer between any suitable positions (i.e., a chair and a wheelchair) can be completed by completing the same steps. First, a wheelchair a user is sitting in can be positioned in front of transfer device 300. The wheels of the wheelchair should be locked to prevent it sliding out from behind the user when using transfer device 300. Belt 358 is then secured to the waist of the user. Belt 358 can be slipped over a user's head or belt 358 can be released from hook 360, wrapped around a user, and then resecured to hook 360. Belt 358 will then be secured to the waist of the user so that padding 358A of belt 358 is positioned on the hips of the user. Padding 358A of belt 358 should not sit below the waist or on the rear of the user. The user should also ensure that belt 358 is secured to hook 360 prior to initiating the lift function. The user's feet should be placed on foot plate 366 and the user should grasp handle 348. The user's knees should be positioned against shin rest 364. The proper positioning of the user in transfer device 300 can be seen in FIG. 11.

To execute a transfer from a wheelchair to a toilet, the user should perform the following steps. First, the user can engage a lift control of controls 362 to execute a lift function. Controls 362 will send a signal to electric winch 354 to wind belt 358 into electric winch 354. As belt 358 is wound into electric winch 354, belt 358 and padding 358A will lift the user from the seated position to a standing position. During the lift function, the same three points of contact will be maintained between transfer device 300 and the user: their hands should remain grasped on handle 348, their knees should remain on shin rest 364, and belt 358 and padding 358A should remain strapped around the user's waist. Once they are fully standing, the user should remove their finger from controls 362. In the event the user does not disengage controls 362, electric winch 354 can include a fail safe that will automatically stop the winding of belt 358 when a certain length of belt 358 has been wound into electric winch 354.

Once the user is standing, the rotation function can be executed. Transfer device 300 can be rotated up to 180 degrees. Without moving the placement of the hands, the user will engage the rotation control of controls 362. The rotation control can be a toggle switch that allows a user to select a right or left rotation (i.e., a clockwise or counterclockwise rotation). Controls 362 will send a signal to rotation motor 316 to actuate rotation mechanism 314. Rotation motor 316 will cause gears 318 to rotate, which in turn will rotate mobile platform 302. The user should limit movement of their body during the rotation function, besides moving their fingers to engage and disengage controls 362. When the desired rotation has been achieved, the user should disengage controls 362.

When the user is in the standing position on transfer device 300, the user can don or doff clothing as needed. For example, after a user has executing the lift function and the rotation function, they can doff their pants prior to executing the lowering function to position themselves on a toilet. A user can also don or doff clothing after executing the lift function and prior to executing the rotation function.

Finally, the lowering function can be executed, for example to lower the user down onto the toilet. The user can engage the lower control of controls 362. Controls 362 can send a signal to electric winch 354 to unwind belt 358, in turn causing the user to be lowered from the standing position to a seated position. For example, a user can lower themselves onto the toilet seat. During the lowering function, the user should not move their feet from foot plate 366 and their hands should remain grasped on handle 348. Once fully seated on the toilet, the user can disengage controls 362. If the user does not disengage controls 362, transfer device 300 will automatically stop unwinding belt 358 when belt 358 has been unwound from electric winch 354. When the user is seated and stable, the user may remove their hands from handle 348, move their feet from foot plate 366 as needed, and use the toilet. To transfer back into the wheelchair when the user is finished using the toilet, the above steps can be followed to transfer from the toilet back to the wheelchair.

Transfer device 300 allows a user to independently execute a sit-to-stand transfer, a pivot transfer, and a stand-to-sit transfer without the assistance of a caregiver. Transfer device 300 is designed to allow a user to don or doff clothing as necessary. This allows a user to transfer from a wheelchair to a commode/toilet. This is especially important in cases where a full time caregiver is not available, as it allows users to transfer between a wheelchair and a commode/toilet independently when a caregiver is not present to assist.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A transfer device comprising:
a mobile platform;
a lifting assembly extending upwards from the mobile platform;
a rotation mechanism forming a part of the mobile platform and configured to rotate the mobile platform; and
a lift mechanism forming a part of the lifting assembly and configured to lift and lower the lifting assembly.

2. The transfer device of claim 1, wherein the mobile platform further comprises:
a base; and
a brace plate positioned below the base and configured to rest upon a floor.

3. The transfer device of claim 2, wherein the rotation mechanism comprises:
a rotation motor;
a first gear coupled to the rotation motor and positioned between the base and the brace plate; and
a second gear coupled to the first gear and positioned between the base and the brace plate.

4. The transfer device of claim 3, wherein the first gear is a planetary gear and the second gear is a stationary gear.

5. The transfer device of claim 3, wherein the base is configured to rotate upon rotation of the second gear.

6. The transfer device of claim 3, wherein the mobile platform further comprises:
one or more wheels connected to the mobile platform, wherein the one or more wheels are configured to be engaged and extend below a bottom of the brace plate to allow the transfer device to be moved, and wherein the one or more wheels are configured to be disengaged where the brace plate will extend below the one or more wheels and rest on a floor to stabilize the transfer device on the floor.

7. The transfer device of claim 1, wherein the lifting assembly includes a boom arm that further comprises:
a set of linkages that are pivotable with respect to one another to lift and lower the boom arm.

8. The transfer device of claim 7, wherein the set of linkages further comprise:
a first arm extending upward from the mobile platform; and
a second arm extending upward from the mobile platform, wherein the first arm and the second arm are connected at a first pivot point.

9. The transfer device of claim 8, wherein:
the first arm comprises:
a first bar; and
a second bar connected to the first bar at a second pivot point; and
the second arm comprises:
a third bar; and
a linear actuator connected to the third bar at a third pivot point, wherein the linear actuator is configured to move between a retracted position and an extended position to lift and lower the boom arm.

10. The transfer device of claim 8, wherein the lifting assembly further comprises:
a handle connected to the first arm that is positioned to be grasped by a user.

11. The transfer device of claim 10, wherein the lifting assembly further comprises:
a rotate control positioned on the handle and coupled to the rotation mechanism; and
a lift control positioned on the handle and coupled to the lift mechanism;
wherein the rotate control and the lift control are positioned on the handle to be easily accessible by the user.

12. The transfer device of claim 10, and further comprising:
one or more hooks connected to the first arm, wherein a transfer belt is configured to be releasably connected to the one or more hooks.

13. The transfer device of claim 1, and further comprising:
a transfer belt that releasably connected to the lifting mechanism, wherein the transfer belt is configured to be wrapped around and secured to a user of the transfer device.

14. The transfer device of claim 1, wherein the lifting assembly comprises:
a first arm extending upward from the mobile platform;
a second arm extending upward from the mobile platform; and
a handle extending between the first arm and the second arm.

15. The transfer device of claim 14, wherein the lifting assembly further comprises:
an electric winch positioned on the mobile platform;
a pulley connected to the first arm; and
a belt having a first end connected to the electric winch and extending through the pulley, wherein the electric winch if configured to wind and unwind the belt.

16. The transfer device of claim 15, wherein a second end of the belt is releasably connected to the second arm, and wherein the belt is configured to be wrapped around a user of the transfer device to lift the transfer device.

17. A method of using a transfer device to lift and rotate a user, the method comprising:
wrapping a belt around a waist of a user;
positioning feet of the user on a mobile platform of the transfer device;
lifting the user from a sitting position to a standing position by actuating a lift mechanism of the transfer device; and
rotating the user by actuating a rotation mechanism of the transfer device.

18. The method of claim 17, wherein lifting the user from the sitting position to the standing position by actuating the lift mechanism of the transfer device further comprises:
actuating a lift control of the transfer device;
sending a signal from the lift control to a linear actuator to actuate the linear actuator; and
extending the linear actuator to extend a boom arm of the transfer device to lift the user from the sitting position to the standing position.

19. The method of claim 17, wherein lifting the user from the sitting position to the standing position by actuating the lift mechanism of the transfer device further comprises:
actuating a lift control of the transfer device;
sending a signal from the lift control to an electric winch to actuate the electric winch; and
winding the belt into the electric winch to lift the user from the sitting position to the standing position.

20. The method of claim 17, wherein rotating the user by actuating the rotation mechanism of the transfer device further comprises:
actuating a rotate control of the transfer device;
sending a signal from the rotate control to a rotate motor to actuate the rotate motor, wherein the rotate motor is connected to a first gear;
rotating the first gear, wherein the first gear is engaged with a second gear; and
rotating the second gear, wherein the mobile platform of the transfer device rotates upon rotation of the second gear.
